(19) United States
(12) Patent Application Publication
(10) Pub. No.: US 2008/0104302 A1
(43) Pub. Date: May 1, 2008

(54) System and method for effectively performing a signal conversion procedure

(75) Inventor: Fredrik Carpio, San Diego, CA (US)

Correspondence Address: Gregory J. Koerner;Redwood Patent Law, 1291 East Hillsdale Boulevard, Suite 205, Foster City, CA, 94404, US

(73) Assignees: Sony Corporation; Sony Electronics Inc.

(21) Appl. No.: 11/731,182

(22) Filed: Mar. 30, 2007

Related U.S. Application Data
(60) Provisional application No. 60/854,738, filed on Oct. 26, 2006.

(51) Int. Cl. G06F 13/20

(52) U.S. Cl. 710/313

(57) ABSTRACT

A system and method for effectively utilizing a converter device to perform a signal conversion procedure includes an input detector module that references an input table to validate input values from converter input signals that are generated by an external signal source such as a local access device for a remote portable computer. Variable mapping logic from the converter device performs a signal translation procedure to correlate the input values from the input table to corresponding output values from an output table. The converter device then utilizes the output values to generate converter output signals for controlling a local electronic device such as a television settop box.

### CROSS-REFERENCE TO RELATED APPLICATION

This Application claims priority in U.S. Provisional Patent Application No. 60/854,738 entitled “LocationFree IR to DirecTV USB Converter,” that was filed on Oct. 26, 2006. The foregoing related Application is commonly owned, and is hereby incorporated by reference.

### BACKGROUND SECTION

1. Field of the Invention

This invention relates generally to techniques for utilizing electronic systems, and relates more particularly to a system and method for effectively performing a signal conversion procedure.

2. Description of the Background Art

Implementing effective methods for utilizing electronic systems is a significant consideration for designers and manufacturers of contemporary electronic systems. However, effectively implementing electronic systems may create substantial challenges for system designers. For example, enhanced demands for increased system functionality and performance may require more system processing power and require additional hardware resources. An increase in processing or hardware requirements may also result in a corresponding detrimental economic impact due to increased production costs and operational inefficiencies.

Furthermore, enhanced system capability to perform various advanced operations may provide additional benefits to a system user, but may also place increased demands on the control and management of various system components. For example, an enhanced electronic system that effectively utilizes audio/video data sources may benefit from an efficient implementation because of the large amount and complexity of the digital data involved.

Due to growing demands on system resources and substantially increasing data magnitudes, it is apparent that developing new techniques for implementing and utilizing television systems is a matter of concern for related electronic technologies. Therefore, for all the foregoing reasons, developing effective systems for implementing and utilizing electronic systems remains a significant consideration for designers, manufacturers, and users of contemporary electronic systems.

### SUMMARY

In accordance with the present invention, a system and method are disclosed for effectively performing a signal conversion procedure. In accordance with one embodiment of the present invention, a microcontroller of a converter device utilizes an initialization module to perform a CPU initialization procedure that specifies appropriate operating parameters and other values for a central-processing unit of the microcontroller. The initialization module may also perform a logic initialization procedure to configure appropriate mapping rules and corresponding criteria for variable mapping logic from the microcontroller.

A valid input detector of the microcontroller continually monitors input values from converter input signals that are received through a local access device from a remote portable computer or other appropriate electronic control device. The valid input detector may refer to an input table of the microcontroller to determine whether a current input value from the converter input signals is listed as a valid input signal in the input table. If the current input value from the converter input signals is valid, then the variable matching logic may perform a signal translation procedure to access a corresponding output value from an output table of the microcontroller.

An output formatter of the microcontroller may utilize the output value to produce an output string to thereby generate a corresponding converter output signal. Finally, the converter device may advantageously transmit the converter output signal in an appropriate and compatible format to control a local electronic device such as a television settop box. For all the foregoing reasons, the present invention therefore provides an improved system and method for effectively performing a signal conversion procedure.

### BRIEF DESCRIPTION OF THE DRAWINGS

FIG. 1 is a block diagram of an electronic system, in accordance with one embodiment of the present invention;

FIG. 2 is a block diagram for one embodiment of the converter of FIG. 1, in accordance with the present invention;

FIG. 3 is a block diagram for one embodiment of the microcontroller of FIG. 2, in accordance with the present invention;

FIG. 4 is a block diagram for one embodiment of the non-volatile memory of FIG. 3, in accordance with the present invention;

FIG. 5 is a block diagram for one embodiment of the input table from FIG. 4, in accordance with the present invention;

FIG. 6 is a block diagram for one embodiment of the output table from FIG. 4, in accordance with the present invention;

FIG. 7 is a diagram illustrating an output formatting procedure, in accordance with one embodiment of the present invention; and

FIGS. 8A and 8B present a flowchart of method steps for performing a signal conversion procedure, in accordance with one embodiment of the present invention.

### DETAILED DESCRIPTION

The present invention relates to an improvement in controlling electronic systems. The following description is presented to enable one of ordinary skill in the art to make and use the invention, and is provided in the context of a patent application and its requirements. Various modifications to the disclosed embodiments will be readily apparent to those skilled in the art, and the generic principles herein may be applied to other embodiments. Thus, the present invention is not intended to be limited to the embodiments shown, but is to be accorded the widest scope consistent with the principles and features described herein.

The present invention is described herein as a system and method for effectively utilizing a converter device to perform a signal conversion procedure, and includes an input detector module that references an input table to validate input values from converter input signals that are generated by an external signal source such as a local access device for a remote portable computer. Variable mapping logic from the converter device performs a signal translation procedure to correlate the input values from the input table to corresponding output values from an output table. The converter device may then utilize the output values to generate converter output signals for controlling a local electronic device such as a television settop box.

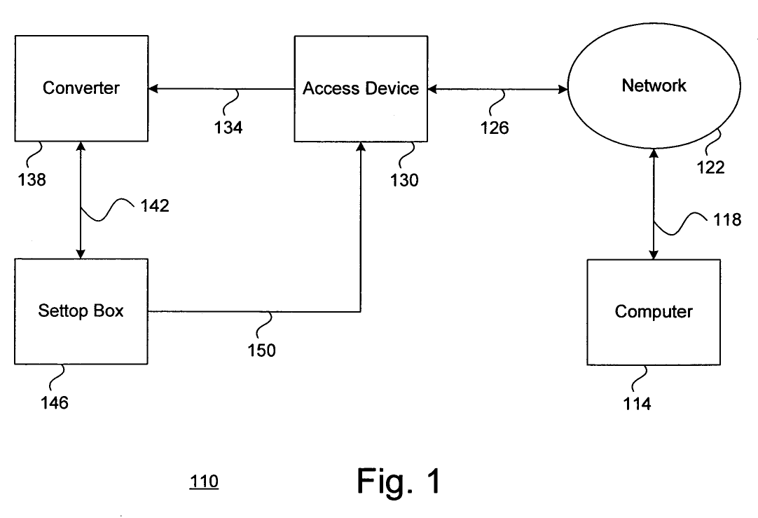

Referring now to FIG. 1, a block diagram of an electronic system 110 is shown, in accordance with one embodiment of the present invention. In the FIG. 1 embodiment, electronic system 110 may include, but is not limited to, a computer 114, a network 122, an access device 130, a converter 138, and a settop box (STB) 146. In alternate embodiments, electronic system 110 may be implemented using components and configurations in addition to, or instead of, certain of those components and configurations discussed in conjunction with the FIG. 1 embodiment.

In the FIG. 1 embodiment, computer 114 may be configured to support and manage various functionalities for utilizing electronic information provided by STB 146 or other appropriate devices in electronic system 110. For example, computer 114 may access and reproduce electronic audio/video content such as motion pictures, television programs, audio data, video games, and other types of electronic information for utilization in remote locations that are distant from STB 146 or any television device coupled to STB 146.

Computer 114 may be alternately implemented as any effective portable or stationary electronic device including, but not limited to, a laptop computer, a personal digital assistant (PDA), a stationary desktop computer, or a cellular telephone. In the FIG. 1 embodiment, computer 114 preferably includes communications software which allows a system user to remotely control and utilize STB 146. For example, a communications module of computer 114 may display an STB remote control interface on a display screen of computer 114 for allowing a system user to remotely generate computer output signals that select one or more desired control functions for operating STB 146. In alternate embodiments, STB 146 may be implemented as any other type of appropriate electronic device including, but not limited to, a television broadcasting receiver, an audio/video recorder device, a computer device, a video camera, a DVD recording device, or a DirecTV device.

In the FIG. 1 embodiment, computer 114 may transmit the foregoing computer output signals through path 118, network 122, and path 126 to an access device 130 that is typically located in the same general vicinity as STB 146. In the FIG. 1 embodiment, network 122 may be implemented as any appropriate network that includes, but is not limited to, the Internet and/or a wireless/wired local-area network (LAN). In the FIG. 1 embodiment, access device 130 receives the computer output signals from computer 114, and converts the computer output signals to converter input signals 134 that are then provided to converter 138. In certain embodiments, access device 130 may perform various types of manipulations or modifications upon the computer output signals. For example, in certain instances, the computer output signals may be converted from digital to analog format.

In the FIG. 1 embodiment, access device 130 may be implemented as any appropriate electronic device or system that transmits control information (from computer 114 or other appropriate entities) through converter 138 to STB 146. For example, in certain embodiments, access device 130 may be implemented as a LocationFree device manufactured by Sony Corporation. In the FIG. 1 embodiment, access device 130 converts the computer output signals from computer 114 into converter input signals 134 that are provided to converter 138 in any effective input signal format. For example, in certain embodiments, access device 130 is configured to generate the converter input signals in a corresponding infrared (IR) format.

In certain conventional systems in which STB 146 includes an infrared control sensor (typically located on the front of STB 146), the IR control signal output of access device 130 may be provided directly from access device 130 to STB box 146 by utilizing a corresponding infrared connection cable (such as a conventional IRBlaster device). However, this solution is less than satisfactory because the IR connection cable must always be carefully aligned with the infrared control sensor on the front of STB 146 to ensure adequate reception of the IR signals. In addition; having the infrared connection cable hanging across the front surfaces of access device 130 and STB 146 to reach the infrared control sensor located on the front of STB 146 may be aesthetically quite undesirable to many system users.

In accordance with the present invention, converter 138 may therefore be advantageously utilized to convert the access device output signals (converter input signals 134) from an infrared format into converter output signals 142 that are appropriately formatted to be provided by a hardwired connection directly to an existing STB connector mounted on the rear of STB 146. The STB connector may be implemented according to any desired standard or technology. For example, in certain embodiments, converter output signals 142 may be provided to STB 146 in accordance with a known universal serial bus (USB) format.

In accordance with the present invention, utilizing converter 138 to perform a signal conversion procedure to translate converter input signals 134 from access device 130 into appropriate converter output signals 142 that are compatible with STB 146 advantageously allows manufacturers of access device 130 and STB 146 to continue to produce these devices with unaltered device designs. In the FIG. 1 embodiment, after STB 146 receives the converter output signals 142, then STB 146 may perform appropriate functions or operations that correspond to the original control selections made with computer 114.

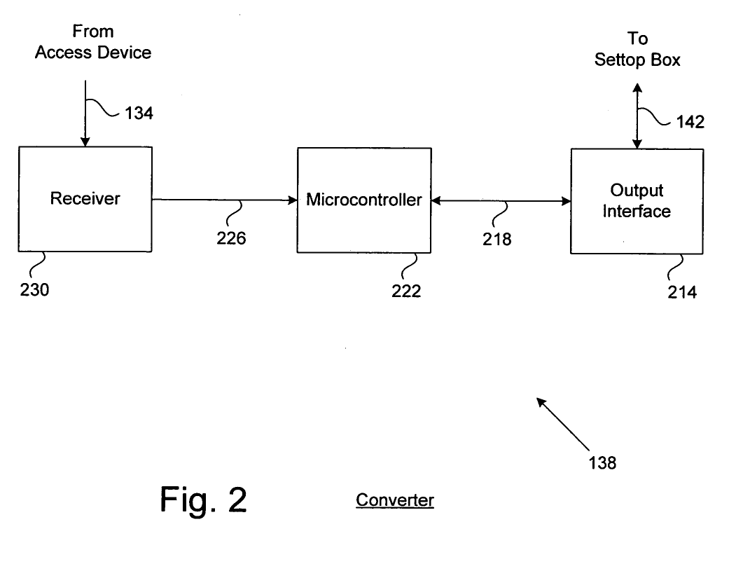

For example, in the FIG. 1 embodiment, STB 146 may be connected to a cable television network or a satellite device to receive and potentially record audio-video programming content. If a system user wishes to remotely view a particular television program, then STB 146 may provide the audio/video content to computer 114 via path 150, access device 130, path 126, network 122, and path 118. The system user may thus effectively utilize converter 138 to support the remote control and utilization of STB 146 in an optimal manner. The implementation and utilization of the FIG. 1 converter 138 is further discussed below in conjunction with FIGS. 2-8.

Referring now to FIG. 2, a block diagram for one embodiment of the FIG. 1 converter 138 is shown, in accordance with the present invention. In the FIG. 2 embodiment, converter 138 may include, but is not limited to, a receiver 230, a microcontroller 222, and an output interface 214. In alternate embodiments, converter 138 may be implemented using components and configurations in addition to, or instead of, certain of those components and configurations discussed in conjunction with the FIG. 2 embodiment.

In the FIG. 2 embodiment, a receiver 230 initially receives the converter input signals 134 via a converter input cable that is coupled to access device 130 (FIG. 1). As discussed above, converter input signals 134 may include settop box control information from a remote computer 114 (FIG. 1) for controlling STB 146 (FIG. 1) or other similar devices. In certain embodiments, access device 130 is implemented to provide the converter input signals 134 in a standard or enhanced infrared transmission format.

In certain embodiments, receiver 230 may include an opto-isolator module that initially receives the converter input signal 134. In the FIG. 2 embodiment, receiver 230 performs a filtering procedure to remove the infrared carrier wave from converter input signal 134 to thereby produce a filtered converter input signal 226 with STB control information encoded in a digital format. Receiver 230 then provides the filtered converter input signal 226 to a microcontroller 222.

In the FIG. 2 embodiment, microcontroller 222 may be implemented in any effective manner to perform a signal translation procedure upon filtered converter input signal 226 to thereby produce a preliminary converter output signal 218. In certain embodiments, microcontroller 222 may be implemented as a standard or enhanced PIC microcontroller unit. In the FIG. 2 embodiment, an output interface 214 may perform a STB formatting procedure to format the preliminary converter output signal 218 according to requirements of the specific chipset of STB. 146. For example, in certain embodiments, output interface 214 may be implemented as a Prolific PL-2303 device to perform a serial-to-USB conversion procedure to thereby provide a final converter output signal 142 to STB 146 (FIG. 1).

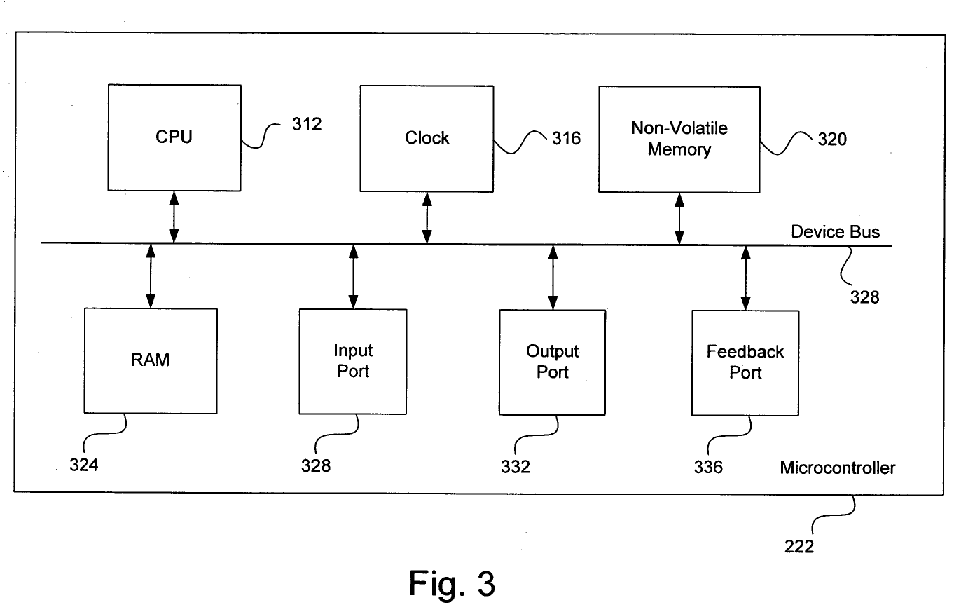

In the FIG. 2 embodiment, the signal path between microcontroller 222 through output interface 214 to STB 146 is bi-directional. STB 146 may therefore provide various types of feedback information to microcontroller 222. For example, in certain embodiments, STB 142 may request microcontroller 222 to resend certain control information (preliminary converter output signal 218) if any type of transmission or data error is detected. Furthermore, in certain embodiments, operating power for converter 138 may be provided from STB 146 through a separate power connection over the same feedback path. Additional details regarding the implementation and utilization of converter 138 are further discussed below in conjunction with FIGS. 3-8.

Referring now to FIG. 3, a block diagram for one embodiment of the FIG. 2 microcontroller 222 is shown, in accordance with the present invention. In the FIG. 3 embodiment, microcontroller 222 may include, but is not limited to, a central-processing unit (CPU) 312, a clock 316, a non-volatile memory 320, a random-access memory (RAM) 324, an input port 328, an output port 332, and a feedback port 336. Selected ones of the foregoing components of microprocessor 222 may be coupled to, and communicate through, a device bus 328. In alternate embodiments, microcontroller 222 may be implemented using components and configurations in addition to, or instead of, certain of those components and configurations discussed in conjunction with the FIG. 3 embodiment.

In the FIG. 3 embodiment, CPU 312 may be implemented to include any appropriate and compatible microprocessor device that preferably executes software instructions to thereby control and manage the operation of microcontroller 114. In the FIG. 3 embodiment, microcontroller 222 may utilizing one or more clock signals from clock 316 to synchronize and time various functions and processes in converter 146. In the FIG. 3 embodiment, non-volatile memory 320 may be implemented to include any combination of desired non-volatile storage devices, including, but not limited to, read-only memory (ROM) or flash memory.

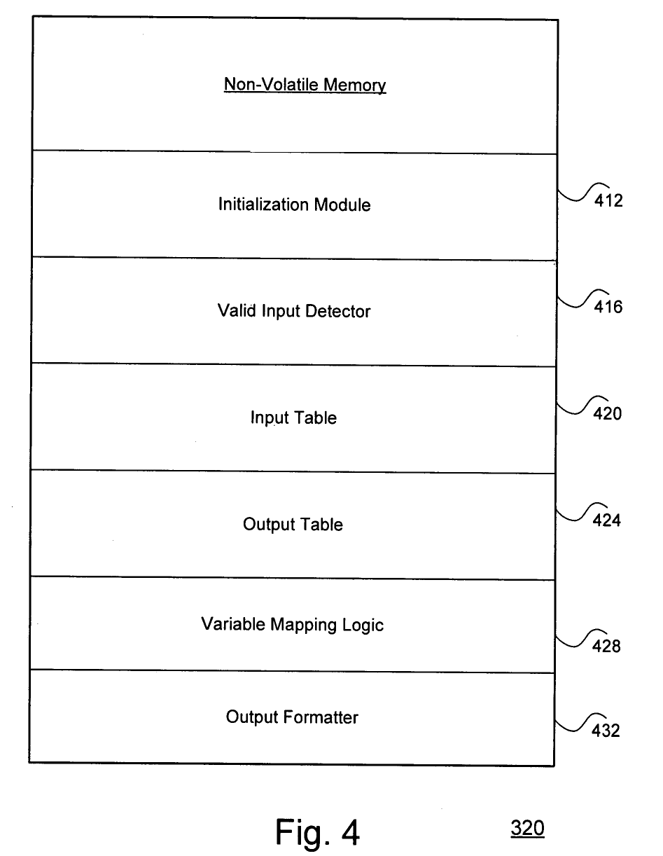

In the FIG. 3 embodiment, microcontroller 222 may utilize random-access memory (RAM) 324 for temporarily storing any appropriate type of data or software instructions. In the FIG. 3 embodiment, input port 328 may receive any type of information, such as converter input signals 134, from access device 130 or other external entities. In the FIG. 3 embodiment, microcontroller 222 may utilize output port 332 to transmit any type of information, such as preliminary converter output signals 218, to access device 130 or other external entities. In the FIG. 3 embodiment, feedback port 336 may be utilized to receive any type of feedback information from access device 130 or other external entities. Additional details regarding the implementation and utilization of microcontroller are further discussed below in conjunction with FIGS. 4-8.

Referring now to FIG. 4, a block diagram for one embodiment of the FIG. 3 non-volatile memory 320 is shown, in accordance with the present invention. In the FIG. 4 embodiment, non-volatile memory 320 includes, but is riot limited to, an initialization module 412, a valid input detector 416, an input table 420, and output table 424, variable mapping logic 428, and an output formatter 432. In alternate embodiments, non-volatile memory 320 may include various other components in addition to, or instead of, certain of those components discussed in conjunction with the FIG. 4 embodiment.

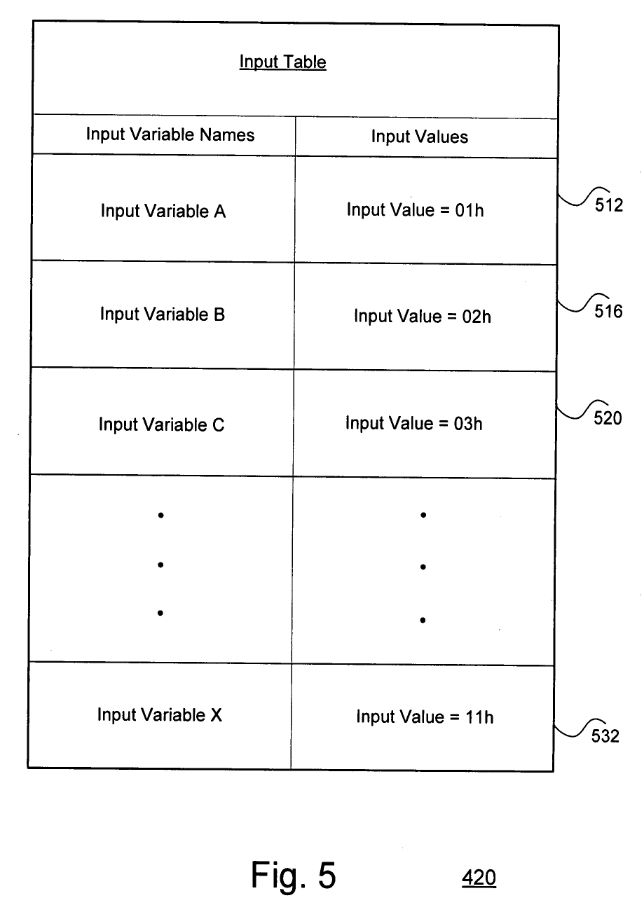

In the FIG. 4 embodiment, microcontroller 222 may utilize initialization module 412 to perform various types of initialization procedures to initialize CPU 312 (FIG. 3) or variable mapping logic 428. In the FIG. 4 embodiment, microcontroller 222 may utilize valid input detector 416 to determine whether input values from received converter input signals 134 (FIG. 2) are present in an input table 420 of valid input values. One example of an input table 420 is further discussed below in conjunction with FIG. 5.

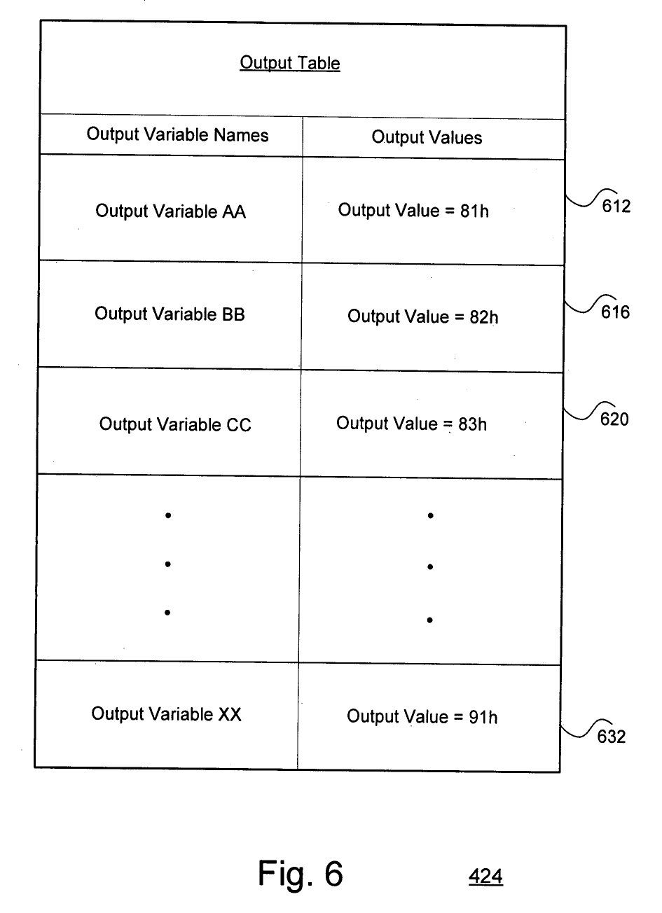

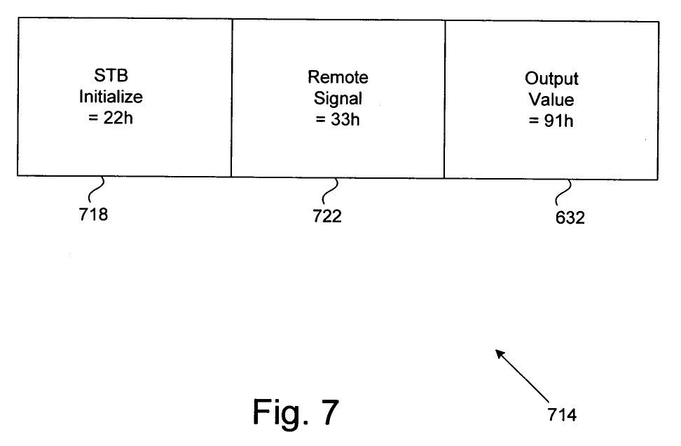

In the FIG. 4 embodiment, microcontroller 222 may utilize pre-determined mapping rules and mapping criteria that are specified in variable mapping logic 428 to associate input variables from input table 420 with corresponding output variables in an output table 424. One example of an output table 424 is further discussed below in conjunction with FIG. 6. In the FIG. 4 embodiment, microcontroller 222 may utilize output formatter 432 to create appropriate output strings for preliminary converter output signals 218 (FIG. 2). In the FIG. 4 embodiment, output formatter 432 may utilize output variables from output table 424 in conjunction with other appropriate control values to format preliminary converter output signals 218. One example for utilizing output formatter 432 is further discussed below in conjunction with FIG. 7.

In the FIG. 4 embodiment, the present invention is disclosed and discussed as being implemented primarily as software. However, in alternate embodiments, some or all of the functions of the present invention may be performed by appropriate electronic hardware circuits that are configured for performing various functions that are equivalent to those functions of the software modules discussed herein. In addition, in certain embodiments of the present invention, any of the software modules shown in FIG. 4 may be updated to facilitate performing signal conversion procedures for various different device versions or device types of computer 114 and/or STB 146.

Referring now to FIG. 5, a block diagram for one embodiment of the FIG. 4 input table 420 is shown, in accordance with the present invention. The FIG. 5 example is presented for purposes of illustration, and in alternate embodiments, the present invention may utilizes input tables that are implemented with values, components, and configurations in addition to, or instead of, certain of those values, components, and configurations discussed in conjunction with the FIG. 5 embodiment.

In the FIG. 5 embodiment, input table 420 includes a column of input variable names on the left, and a column of corresponding input values on the right. For example, input table 420 includes a top row 512 with an input variable A and a corresponding input value, 01 hexidecimal (01h). In the FIG. 5 embodiment, the input variable names may include any type of information that typically represents corresponding respective control functions for STB 146 (FIG. 1). For example, in the FIG. 5 example, input variable A may represent a “store” function for STB 146.

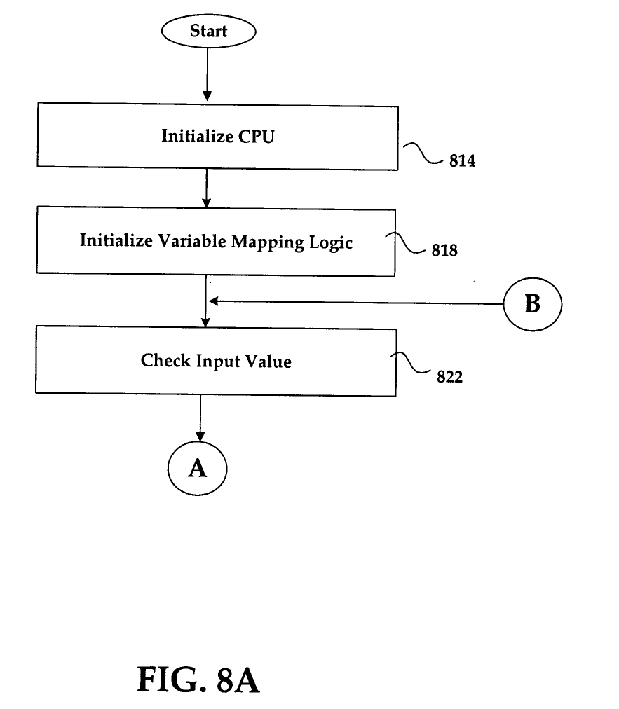

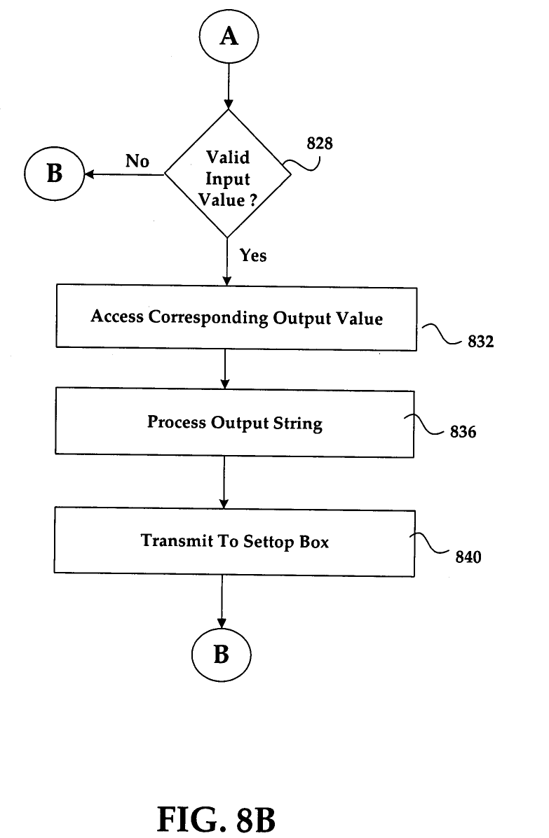

In the FIG. 5 embodiment of input table 420, the input values represent various possible types of control information found in filtered converter input signals 226 (FIG. 2) that were original transmitted from computer 114 (or other appropriate entities). In the FIG. 5 embodiment, each of the the input values corresponds to an input variable that is located in the same horizontal row of input table 420. For example, in row 512 of input table 420, an input value of 01h corresponds to input variable A. In the FIG. 5 embodiment, the input values are shown in hexadecimal format. However, in alternate embodiments, any other effective type of format is equally contemplated. Additional details regarding the utilization of input table 420 are further discussed below in conjunction with FIG. 8.

Referring now to FIG. 6, a block diagram for one embodiment of the FIG. 4 output table 424 is shown, in accordance with the present invention. The FIG. 6 example is presented for purposes of illustration, and in alternate embodiments, the present invention may utilizes output tables that are implemented with values, components, and configurations in addition to, or instead of, certain of those values, components, and configurations discussed in conjunction with the FIG. 6 embodiment.

In the FIG. 6 embodiment, output table 424 includes a column of output variable names on the left, and a column of corresponding output values on the right. For example, output table 424 includes a top row 612 with an output variable AA and a corresponding output value, 81 hexidecimal (81h). In the FIG. 6 embodiment, the output variable names may include any type of information that typically represents corresponding respective control functions for STB 146 (FIG. 1). For example, in the FIG. 6 example, output variable AA may represent a “store” function for STB 146.

In the FIG. 6 embodiment of output table 424, the output values represent various possible types of control information for inclusion by microcontroller 222 in preliminary converter output signals 218 (FIG. 2). In the FIG. 6 embodiment, each of the the output values corresponds to an output variable that is located in the same horizontal row of output table 424. For example, in row 612 of output table 424, an output value of 81h corresponds to output variable AA. In the FIG. 6 embodiment, the output values are shown in hexadecimal format. However, in alternate embodiments, any other effective type of format is equally contemplated.

In the FIG. 6 embodiment, microcontroller 222 may utilize variable mapping logic 428 (FIG. 4) to perform a signal translation procedure to convert filtered converter input signals 226 into preliminary converter output signals 218. In particular, the CPU 312 of microcontroller 222 may initially utilize input table 420 (FIG. 5) to identify various input variables corresponding to respective input values from filtered converter input signals 226. Variable mapping logic 428 of microcontroller 222 may next be utilized to map each input variable from input table 420 to a corresponding respective one of the output variables from output table 424 in accordance with pre-determined mapping rules and criteria. CPU 312 may then utilize output table 420 to identify output values corresponding to the respective mapped output variables for populating preliminary converter output signals 218. Additional details regarding the utilization of output table 424 are further discussed below in conjunction with FIGS. 7-8.

Referring now to FIG. 7, a diagram illustrating an output formatting procedure is shown, in accordance with one embodiment of the present invention. The FIG. 7 example is presented for purposes of illustration, and in alternate embodiments, the present invention may perform output formatting procedure by utilizing values, components, and configurations in addition to, or instead of, certain of those values, components, and configurations discussed in conjunction with the FIG. 7 embodiment.

In the FIG. 7 embodiment, an output formatter 432 (FIG. 3) may perform a converter output formatting procedure to generate appropriate output strings for preliminary converter output signals 218 (FIG. 2). In the FIG. 7 embodiment, output formatter 432 may utilize output variables from output table 424 (FIG. 6) and other appropriate values to format preliminary converter output signals 218. For example, in addition to the basic output variable from output table 424, output formatter 432 may add certain additional values to support functions and requirements of STB 146. In addition, output formatter 432 may add appropriate timing or formatting information.

In the FIG. 7 example, an exemplary output string 714 for preliminary converter output signal 218 includes an output value 632 from the FIG. 6 output table 632. However, output string 714 also includes an STB initialize value of 22h and a remote signal value of 33h that are added by output formatter 432.

Referring now to FIGS. 8A and 8B, a flowchart of method steps for performing a signal conversion procedure is shown, in accordance with one embodiment of the present invention. The embodiment of FIGS. 8A-8B is presented for purposes of illustration, and in alternate embodiments, the present invention may readily utilize steps and sequences other than those steps and sequences discussed in conjunction with the embodiment of FIGS. 8A-8B.

In step 814 of FIG. 8A, a microcontroller 222 of a converter 138 (FIG. 2) utilizes an initialization module 412 to perform a CPU initialization procedure that specifies appropriate operating parameters and other values for the CPU 312 of microcontroller 222. In step 818, the initialization module 412 may perform a logic initialization procedure to setup appropriate mapping rules and criteria for variable mapping logic 428 (FIG. 4). In step 822, a valid input detector 416 of microcontroller 222 continually checks input values from filtered converter input signals 226 (FIG. 2). The FIG. 8 process may then advance to step 828 of FIG. 8B through the connection letter “A.”

In step 828, valid input detector 416 may refer to an input table 420 (FIG. 5) of microcontroller 222 to determine whether a current input value from the filtered converter input signals 226 is listed in input table 420 (and is therefore a valid input signal). If the current input value from filtered converter input signals 226 is not valid, then the FIG. 8B process may return to step 822 of FIG. 8A through connection letter “B.”

However, if the current input value from filtered converter input signals 226 is valid, then in step 832, the variable matching logic 428 may perform a signal translation procedure to access a corresponding output value from an output table 424 of microcontroller 222. In step 836, an output formatter 432 of microcontroller 222 may utilize the output value to process an output string to thereby generate a corresponding converter output signal 218. Finally, in step 840, converter 138 may advantageously transmit the converter output signal 218 to STB 146 in an appropriate and compatible format.

The FIG. 8 process may then return to step 822 of FIG. 8A through connection letter “B” to repeatedly convert additional input values into corresponding output values for effectively controlling STB 146. For all the foregoing reasons, the present invention therefore provides an improved system and method for effectively performing a signal conversion procedure.

The invention has been explained above with reference to certain embodiments. Other embodiments will be apparent to those skilled in the art in light of this disclosure. For example, the present invention may readily be implemented using configurations and techniques other than those described in the embodiments above. Additionally, the present invention may effectively be used in conjunction with systems other than those described above. Therefore, these and other variations upon the discussed embodiments are intended to be covered by the present invention, which is limited only by the appended claims.

What is claimed is:

1. A system for utilizing a converter to perform a signal conversion procedure, comprising:
a valid input detector that refers to an input table to validate input values from converter input signals that are generated by an external signal source;
variable mapping logic that performs a translation procedure to correlate said input values from said input table to output values from an output table, said converter utilizing said output values to generate converter output signals for controlling an electronic device; and
a microcontroller that controls said valid input detector and said variable mapping logic for performing said signal conversion procedure.

2. The system of claim 1 wherein said variable mapping logic associates input variables in said input table with corresponding output variables in said output table to correlate said input values to said output values.

3. The system of claim 1 wherein said converter input signals are provided to said converter in an infrared signal format.

4. The system of claim 1 wherein said converter output signals are generated by said converter in a universal-serial bus signal format.

5. The system of claim 1 wherein said electronic device is implemented as a television settop box.

6. The system of claim 5 wherein said external signal source is implemented as an access device coupled to an electronic network.

7. The system of claim 1 wherein said converter input signals are initially generated by a remote portable computer.

8. The system of claim 7 wherein said converter input signals include control information for said electronic device from said remote portable computer.

9. The system of claim 8 wherein said settop box transmits audio/video programming to said remote portable computer through said access device under control of said converter output signals.

10. The system of claim 1 wherein said converter includes a receiver that filters out a carrier wave from said converter input signal, said microcontroller, and an output interface that formats said converter output signal to conform to signal requirements of said electronic device.

11. The system of claim 10 wherein said microcontroller includes a central-processing unit, a timing clock, a non-volatile memory, random-access memory, an input port for receiving said converter input signal, and output port for transmitting said converter output signal, and a feedback port for receiving transmission error information from said electronic device.

12. The system of claim 11 wherein said non-volatile memory includes an initialization module, said valid input detector, said input table, said output table, said variable mapping logic, and an output formatter.

13. The system of claim 12 wherein any stored items in said non-volatile memory are freely updatable to allow said converter to be utilized with different input devices and/or different output devices.

14. The system of claim 1 wherein said converter includes an input cable for receiving said converter input signals and an output cable for transmitting said converter output signals, said input cable being connecting to a back-surface connector of said external signal source, said output cable being connectable to a rear-surface connector of said electronic device so that neither said input cable nor said output cable are visible from areas in front of said external signal source or said electronic device.

15. The system of claim 1 wherein said electronic device sends transmission errors signals to said converter through a feedback path to request resending one of said converter output signals, said converter also receiving operating power from said electronic device via a separate power connector from said feedback path.

16. The system of claim 1 wherein an initialization module of said converter performs separate initialization procedures to provide operating parameters to a central-processing unit of said converter, and to specify mapping rules and mapping criteria for said variable mapping logic.

17. The system of claim 1 wherein said input table includes a series of input values for said converter input signals, said input table also including a series of input variables that each corresponds to a respective one of said input values.

18. The system of claim 1 wherein said output table includes a series of output variables, said output table also including a series of output values that each corresponds to a respective one of said output variables.

19. The system of claim 1 wherein said variable mapping logic performs said translation procedure by utilizing said input table to identify a target input variable that corresponds to a received one of said input values, said variable mapping logic next utilizing pre-defined mapping rules to correlate said target input variable to a target output variable from said output table, said variable mapping logic then utilizing said output table to identify a final one of said output values that corresponds to said target output variable.

20. The system of claim 1 further comprising an output formatter that finalizes said converter output signals by combining said output values with one or more additional control values that support corresponding operational functions of said electronic device.

21. A method for utilizing a converter to perform a signal conversion procedure, comprising the steps of:
referring to an input table with a valid input detector to validate input values from converter input signals that are generated by an external signal source;
performing a translation procedure with variable mapping logic to correlate said input values from said input table to output values from an output table, said converter utilizing said output values to generate converter output signals for controlling an electronic device; and
controlling said valid input detector and said variable mapping logic with a microcontroller to perform said signal conversion procedure.

22. The method of claim 21 wherein said variable mapping logic associates input variables in said input table with corresponding output variables in said output table to correlate said input values to said output values.

23. The method of claim 21 wherein said converter input signals are provided to said converter in an infrared signal format.

24. The method of claim 21 wherein said converter output signals are generated by said converter in a universal-serial bus signal format.

25. The method of claim 21 wherein said electronic device is implemented as a television settop box.

26. The method of claim 25 wherein said external signal source is implemented as an access device coupled to an electronic network.

27. The method of claim 21 wherein said converter input signals are initially generated by a remote portable computer.

28. The method of claim 27 wherein said converter input signals include control information for said electronic device from said remote portable computer.

29. The method of claim 28 wherein said settop box transmits audio/video programming to said remote portable computer through said access device under control of said converter output signals.

30. The method of claim 21 wherein said converter includes a receiver that filters out a carrier wave from said converter input signal, said microcontroller, and an output interface that formats said converter output signal to conform to signal requirements of said electronic device.

31. The method of claim 30 wherein said microcontroller includes a central-processing unit, a timing clock, a non-volatile memory, random-access memory, an input port for receiving said converter input signal, and output port for transmitting said converter output signal, and a feedback port for receiving transmission error information from said electronic device.

32. The method of claim 31 wherein said non-volatile memory includes an initialization module, said valid input detector, said input table, said output table, said variable mapping logic, and an output formatter.

33. The method of claim 32 wherein any stored items in said non-volatile memory are freely updatable to allow said converter to be utilized with different input devices and/or different output devices.

34. The method of claim 21 wherein said converter includes an input cable for receiving said converter input signals and an output cable for transmitting said converter output signals, said input cable being connecting to a back-surface connector of said external signal source, said output cable being connectable to a rear-surface connector of said electronic device so that neither said input cable nor said output cable are visible from areas in front of said external signal source or said electronic device.

35. The method of claim 21 wherein said electronic device sends transmission errors signals to said converter through a feedback path to request resending one of said converter output signals, said converter also receiving operating power from said electronic device via a separate power connector from said feedback path.

36. The method of claim 21 wherein an initialization module of said converter performs separate initialization procedures to provide operating parameters to a central-processing unit of said converter, and to specify mapping rules and mapping criteria for said variable mapping logic.

37. The method of claim 21 wherein said input table includes a series of input values for said converter input signals, said input table also including a series of input variables that each corresponds to a respective one of said input values.

38. The method of claim 21 wherein said output table includes a series of output variables, said output table also including a series of output values that each corresponds to a respective one of said output variables.

39. The method of claim 21 wherein said variable mapping logic performs said translation procedure by utilizing said input table to identify a target input variable that corresponds to a received one of said input values, said variable mapping logic next utilizing pre-defined mapping rules to correlate said target input variable to a target output variable from said output table, said variable mapping logic then utilizing said output table to identify a final one of said output values that corresponds to said target output variable.

40. The method of claim 21 further comprising an output formatter that finalizes said converter output signals by combining said output values with one or more additional control values that support corresponding operational functions of said electronic device.

41. A system for utilizing a converter to perform a signal conversion procedure, comprising:
means for referring to an input table to validate input values from converter input signals that are generated by an external signal source;
means for performing a translation procedure to correlate said input values from said input table to output values from an output table, said converter utilizing said output values to generate converter output signals for controlling an electronic device; and
means for controlling said valid input detector and said variable mapping logic to perform said signal conversion procedure.

42. A converter device for performing a signal conversion procedure, comprising:
a valid input detector that references an input table to validate input values from converter input signals;
variable mapping logic that correlates said input values from said input table to output values from an output table; and
a microcontroller that controls said valid input detector and said variable mapping logic.
